(19) United States
(12) Patent Application Publication
(10) Pub. No.: US 2024/0406104 A1
(43) Pub. Date: Dec. 5, 2024

(54) ADAPTIVE TRAFFIC FORWARDING OVER MULTIPLE CONNECTIVITY SERVICES

(71) Applicant: VMware, Inc., Palo Alto, CA (US)

(72) Inventors: Gaurav JINDAL, Pune (IN); Chandan GHOSH, Bangalore (IN)

(21) Appl. No.: 18/227,334

(22) Filed: Jul. 28, 2023

(30) Foreign Application Priority Data
May 31, 2023 (IN) 202341037603

(51) Int. Cl. H04L 45/00; H04L 43/0811; H04L 45/02

(52) U.S. Cl. CPC H04L 45/70; H04L 43/0811; H04L 45/02

(57) ABSTRACT

Example methods and systems for adaptive traffic forwarding are described. In one example, a first computer system may monitor metric information associated with at least a first connectivity service from multiple connectivity services that are connecting (a) the first computer system and a second computer system. In response to determination that a condition for scaling up is satisfied based on the metric information, the first computer system may select, from a set of multiple flows associated with the first connectivity service, a subset that includes at least a first flow. Routing information may be updated to associate the subset with a second connectivity service. In response to detecting egress packets associated with the first flow from the first endpoint, the first computer system may forward the egress packets towards the second computer system using the second connectivity service based on the updated routing information.

### RELATED APPLICATIONS

Benefit is claimed under 35 U.S.C. 119 (a)-(d) to Foreign Application Serial No. 202341037603 filed in India entitled “ADAPTIVE TRAFFIC FORWARDING OVER MULTIPLE CONNECTIVITY SERVICES”, on May 31, 2023, by VMware, Inc., which is herein incorporated in its entirety by reference for all purposes.

### BACKGROUND

Virtualization allows the abstraction and pooling of hardware resources to support virtual machines in a software-defined data center (SDDC). For example, through server virtualization, virtualization computing instances such as virtual machines (VMs) running different operating systems may be supported by the same physical machine (e.g., referred to as a “host”). Each VM is generally provisioned with virtual resources to run a guest operating system and applications. The virtual resources may include central processing unit (CPU) resources, memory resources, storage resources, network resources, etc. In practice, a user (e.g., organization) may run VMs using on-premises data center infrastructure that is under the user's private ownership and control. Additionally, the user may run VMs in the cloud using infrastructure under the ownership and control of a public cloud provider. It is desirable to improve the performance of traffic forwarding among VMs deployed in different cloud environments.

### BRIEF DESCRIPTION OF DRAWINGS

FIG. 1 is a schematic diagram illustrating an example software-defined networking (SDN) environment in which adaptive traffic forwarding over multiple connectivity services may be performed;

FIG. 2 is a flowchart of an example process for a first computer system to perform adaptive traffic forwarding over multiple connectivity services;

FIG. 3 is a flowchart of an example detailed process for a first computer system to perform adaptive traffic forwarding over multiple connectivity services;

FIG. 4 is a schematic diagram illustrating an example metric information monitoring to facilitate adaptive traffic forwarding;

FIG. 5 is a schematic diagram illustrating an example adaptive traffic forwarding when a condition for scaling UP is satisfied;

FIG. 6 is a schematic diagram illustrating an example adaptive traffic forwarding when a condition for scaling DOWN is satisfied;

FIG. 7 is a flowchart of an example process for a first computer system to perform adaptive traffic forwarding over multiple connectivity services based on control information from a management entity; and

FIG. 8 is a schematic diagram illustrating an example physical implementation view of endpoints in an SDN environment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the drawings, can be arranged, substituted, combined, and designed in a wide variety of different configurations, all of which are explicitly contemplated herein. Although the terms “first” and “second” are used to describe various elements, these elements should not be limited by these terms. These terms are used to distinguish one element from another. For example, a first element may be referred to as a second element, and vice versa.

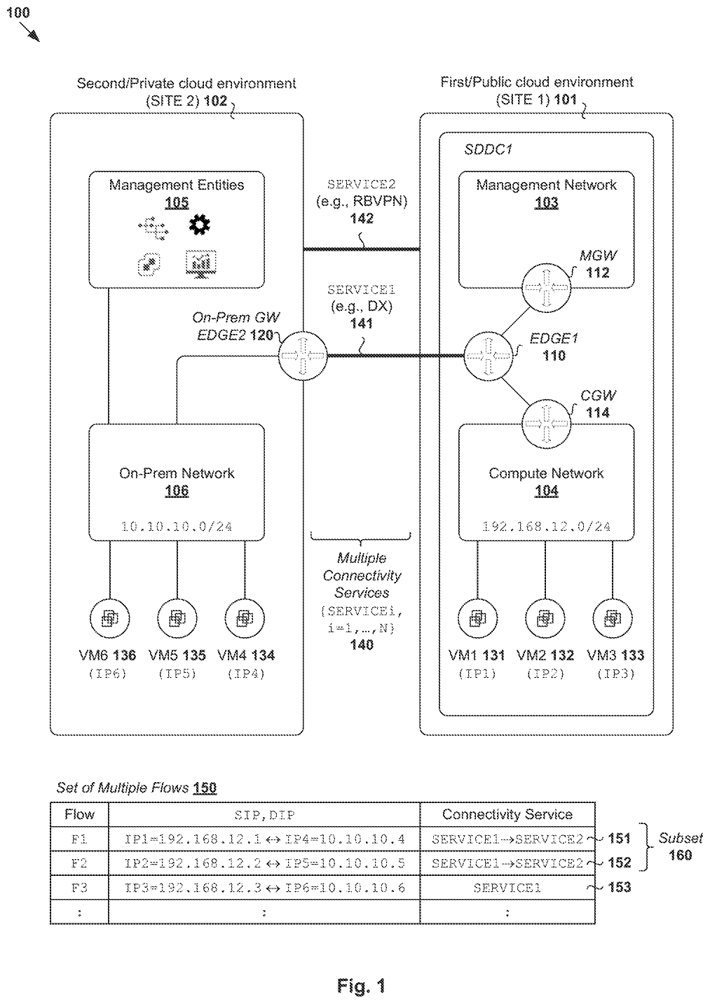

FIG. 1 is a schematic diagram illustrating example software-defined networking (SDN) environment 100 in which adaptive traffic forwarding may be performed. It should be understood that, depending on the desired implementation, SDN environment 100 may include additional and/or alternative components than that shown in FIG. 1. Although the terms “first” and “second” are used to describe various elements, these elements should not be limited by these terms. These terms are used to distinguish one element from another. For example, a first element may be referred to as a second element, and vice versa.

In the example in FIG. 1, SDN environment 100 spans across multiple geographical sites, such as a first geographical site where public cloud environment 101 (“first cloud environment”) is located, a second geographical site where private cloud environment 102 (“second cloud environment”) is located, etc. In practice, the term “private cloud environment” may refer generally to an on-premises data center or cloud platform supported by infrastructure that is under an organization's private ownership and control. In contrast, the term “public cloud environment” may refer generally a cloud platform supported by infrastructure that is under the ownership and control of a public cloud provider. Depending on the desired implementation, both cloud environments 101-102 may be private (i.e., on-premises data centers) or public.

In practice, a public cloud provider is generally an entity that offers a cloud-based platform to multiple users or tenants. This way, a user may take advantage of the scalability and flexibility provided by public cloud environment 101 for data center capacity extension, disaster recovery, etc. Throughout the present disclosure, public cloud environment 102 will be exemplified using VMware Cloud™ (VMC) on Amazon Web Services® (AWS) and Amazon Virtual Private Clouds (VPCs). Amazon VPC and Amazon AWS are registered trademarks of Amazon Technologies, Inc. It should be understood that any additional and/or additional cloud technology may be implemented, such as Microsoft Azure®, Google Cloud Platform™, IBM Cloud™, etc.

To facilitate cross-cloud traffic forwarding, a pair of edge devices may be deployed at the respective first site and second site. In particular, a first computer system capable of acting as EDGE1 110 (“first edge device”) may be deployed at the edge of public cloud environment 101 to handle traffic to/from private cloud environment 102. A second computer system capable of acting as EDGE2 120 (“second edge device”) may be deployed at the edge of private cloud environment 102 to handle traffic to/from public cloud environment 101. Here, the term “network edge,” “edge gateway,” “edge node” or simply “edge” may refer generally to any suitable computer system that is capable of performing functionalities of a gateway, switch, router (e.g., logical service router), bridge, edge appliance, or any combination thereof.

EDGE 110/120 may be implemented using one or more virtual machines (VMs) and/or physical machines (also known as “bare metal machines”). Each EDGE node may implement a logical service router (SR) to provide networking services, such as gateway service, domain name system (DNS) forwarding, IP address assignment using dynamic host configuration protocol (DHCP), source network address translation (SNAT), destination NAT (DNAT), deep packet inspection, etc. When acting as a gateway, an EDGE node may be considered to be an exit point to an external network.

Referring to public cloud environment 101 in FIG. 1, EDGE1 110 may represent a tier-0 edge gateway that is connected with tier-1 management gateway 112 (see “MGW”) and tier-1 compute gateway 114 (see “CGW”). MGW 112 may be deployed to handle management-related traffic to and/or from management entities residing on management network 152 within public cloud environment 101. CGW 114 may be deployed to handle workload-related traffic to and/or from VMs residing on compute network 104, such as VMs 131-133 on first network=192.168.12.0/24. The Internet Protocol (IP) addresses assigned to VMs 131-133 are denoted as (IP1=192.168.12.1, 192.168.12.2, 192.168.12.3), respectively. In this example, EDGE1 110 is configured with three interfaces: Intranet (i.e., uplink using SERVICE1 141), Internet (i.e., uplink using SERVICE2 142) as well as a connected VPC for traffic that is egress or ingress in the north-south direction.

Referring to private cloud environment 102 in FIG. 1, EDGE2 120 may be connected to various logical routers and/or logical switches (not shown for simplicity) to handle management-related traffic from management entities 105, as well as workload-related traffic from various VMs residing on an on-premises network 106, such as VMs 134-136 residing on second network=10.10.10.0/24. The IP addresses assigned to VMs 134-136 are denoted as (IP4=10.10.10.4, IP5=10.10.10.5, IP6=10.10.10.6), respectively.

In the example in FIG. 1, multiple (N) connectivity services 140 may be configured to connect endpoints in public cloud environment 101 with endpoints in private cloud environment 102. Using N=2 as an example, a first connectivity service (denoted as SERVICE1 141) may be a dedicated link to support traffic that require higher bandwidth and lower latency, such as AWS Direct Connect (DX) provides a dedicated network connection between on-premises network infrastructure and a virtual interface (VIF) in an AWS VPC. For example, the dedicated connection may be established over a standard 1 Gigabit per second (Gbps), 10 Gbps or 100 Gbps Ethernet fiber-optic cable. Since SERVICE1 141 relies on a dedicated network connection, it provides more consistent network performance and better security compared to a service that relies on the public Internet.

A second connectivity service (denoted as SERVICE2 142) may be a route-based virtual private network (VPN) or RBVPN, which involves establishing an Internet Protocol Security (IPSec) tunnel for forwarding traffic between public cloud environment 101 and private cloud environment 102. Since the VPN service generally relies on public network infrastructure, its bandwidth and latency may fluctuate. Any suitable protocol may be implemented to discover and propagate routes as networks are added and removed, such as border gateway protocol (BGP), etc.

Referring to public cloud environment 101, all north-south traffic may be forwarded or steered via EDGE1 110. In practice, consider a scenario where SERVICE1 141 (e.g., AWS DX) has been configured as a primary service, and SERVICE2 142 (e.g., VPN) as a backup or secondary service that is only active in the event of a failure associated with SERVICE1 141. In this case, for cross-cloud traffic, EDGE1 110 may forward all traffic flows towards EDGE2 120 using SERVICE1 141 (e.g., a single 1 Gbps link or 2 Gbps link). Conventionally, once SERVICE1 141 becomes saturated and/or approaches its bandwidth limit, EDGE1 110 is unable to take advantage of the available bandwidth provided by SERVICE2 142 due to protocol limitations. This may affect the performance of various cross-cloud traffic flows, which is undesirable.

### Adaptive Traffic Forwarding

According to examples of the present disclosure, adaptive traffic forwarding may be implemented based on metric information to distribute traffic over multiple connectivity services. Using examples of the present disclosure, the bandwidth of one service (e.g., SERVICE1 141) may be scaled UP using available bandwidth of at least one other service (e.g., SERVICE2 142), thereby reducing the likelihood of performance degradation due to high volume of traffic over one service (e.g., SERVICE1 141). It should be understood that examples of the present disclosure may be implemented by EDGE1 110 and/or EDGE2 120 to facilitate intelligent traffic routing to improve the performance of cross-cloud traffic forwarding.

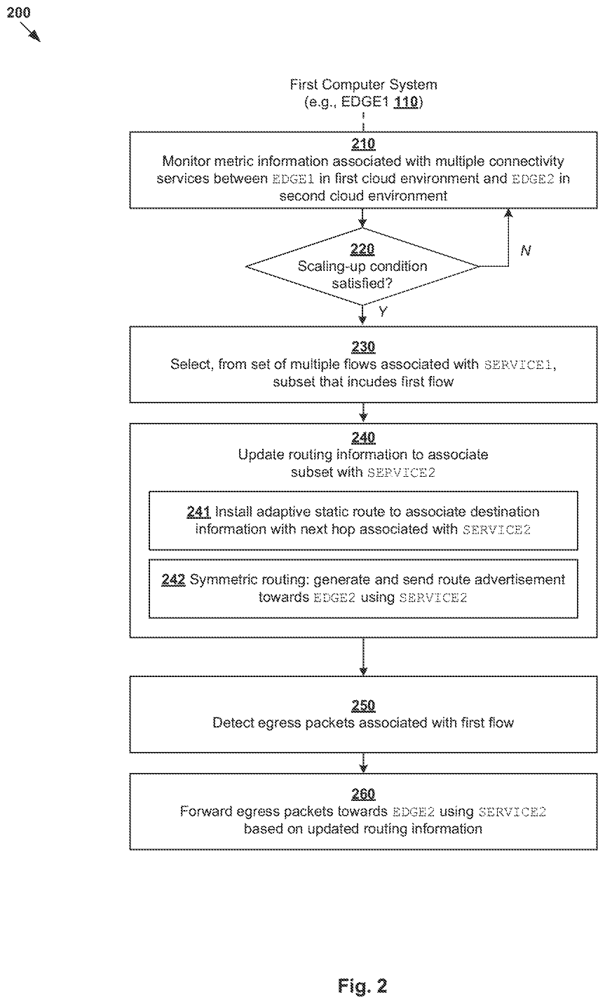

In more detail, FIG. 2 is a flowchart of example process 200 for a first edge device to perform adaptive traffic forwarding. Example process 200 may include one or more operations, functions, or actions illustrated by one or more blocks, such as 210 to 260. Depending on the desired implementation, various blocks may be combined into fewer blocks, divided into additional blocks, and/or eliminated. In the following, various examples will be explained using (a) an example “first computer system” in the form of EDGE1 110 located in first cloud environment 101 at a first geographical site and (b) an example “second computer system” in the form of EDGE2 120 located in second cloud environment 102 at a second geographical site.

At 210 in FIG. 2, EDGE1 110 may monitor metric information associated with SERVICE1 141 from multiple (N) connectivity services 140 that are connecting EDGE1 110 and EDGE2 120. For example in FIG. 1, multiple (N) connectivity services 140 may include SERVICE1 141 (e.g., DX) configured as a primary service and SERVICE2 142 (e.g., VPN) configured as a backup service.

At 220-230 in FIG. 2, in response to determination that a condition for scaling UP is satisfied based on the metric information, EDGE1 110 may select at least a first flow from a set of multiple flows associated with SERVICE1 141. Depending on the desired implementation, block 220 may involve determining whether a threshold value is exceeded for a threshold period of time based on the metric information. Any suitable metric information may be monitored, such as throughput, cumulative bandwidth, etc.

The subset selection at block 230 may be performed based on any suitable policy, which may be a user-configurable policy (e.g., configured by a network administrator) and/or default policy. For example, selected subset 160 may include a first flow (denoted as F1) and a second flow (F2) but exclude a third flow (F3). In this case, the policy may specify a whitelist of application segment(s) or traffic type(s) movable from one service to another service. The policy may also specify a blacklist of application segment(s) or traffic type(s) that should not be moved from one service to another. The whitelist and/or blacklist may be updated by the user from time to time. If no policy is configured by the user, a default policy may be implemented to select subset 160 based on an amount of available bandwidth associated with SERVICE2 142 and an amount of bandwidth required by F1 or F2. See 151-152 and 160 in FIG. 1.

At 240 in FIG. 2, EDGE1 110 may update routing information to associate the subset with SERVICE2 142 instead of SERVICE1 141. For example, at 241, block 240 may involve installing an adaptive static route that associates a destination address of the first flow in subset 160 with a next hop (e.g., interface) associated with SERVICE2 142. Optionally, at 242, to facilitate symmetric routing for the return traffic, EDGE1 110 may generate and send route advertisement(s) associated with the first flow towards EDGE2 120 using SERVICE2 142.

At 250-260 in FIG. 2, in response to detecting egress packets from a first endpoint associated with the first flow, EDGE1 110 may forward the egress packets towards EDGE2 120 using SERVICE2 142 based on the updated routing information. Once received, EDGE2 120 may forward the egress packets towards a second endpoint in private cloud environment 102.

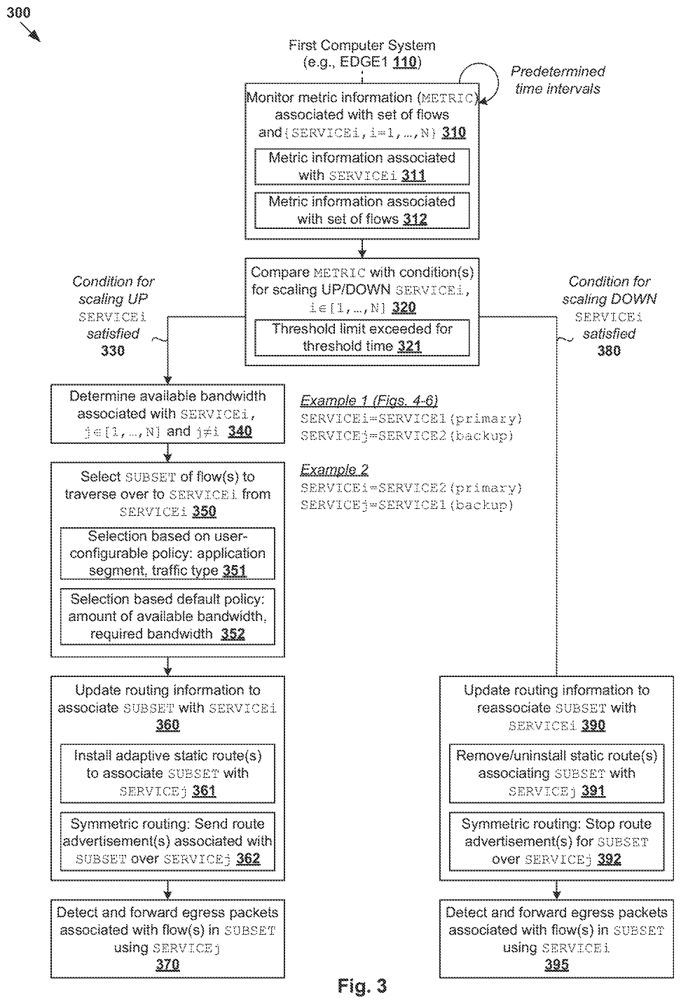

Using examples of the present disclosure, traffic may be distributed over multiple (N) connectivity services in a more adaptive manner based on metric information that is monitored in real time. In practice, it should be understood that N>2 services may be configured and one service (denoted as SERVICEi) may be scaled UP using any other service (SERVICEj) where i,j∈[1, . . . , N] and j≠i. Various examples will be discussed using FIGS. 3-7 below.

### Metric Information Monitoring

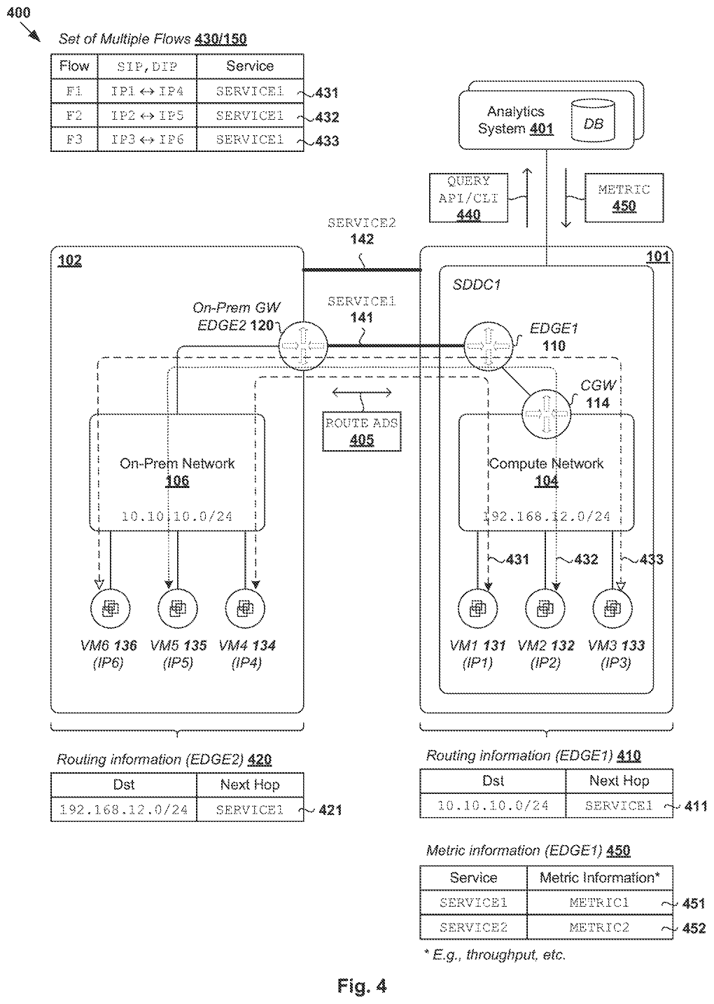

FIG. 3 is a flowchart of example detailed process 300 for a first computer system to perform adaptive traffic forwarding over multiple connectivity services. Example process 300 may include one or more operations, functions, or actions illustrated by one or more blocks, such as 310 to 395. Depending on the desired implementation, various blocks may be combined into fewer blocks, divided into additional blocks, and/or eliminated. Some examples will be described using FIG. 4, which is a schematic diagram illustrating example metric information monitoring 400 to facilitate adaptive traffic forwarding over multiple connectivity services. Compared to FIG. 1, management entities 103/105 are not shown for simplicity.

### (a) Routing Information (i.e., Prior to Scaling UP)

Referring first to FIG. 4, VMs 131-133 are connected to first application segment or network=192.168.12.0/24 in public cloud environment 101. For example, VM1 131 may be assigned with an Internet Protocol (IP) address denoted as IP1=192.168.12.1, while VM2 132 and VM3 133 are assigned with respective IP2=192.168.12.2 and IP3=192.168.12.3. Further, VMs 134-136 in on-premises data center 102 may be connected to second network=10.10.10.0/24. For example, VM4 134, VM5 135 and VM6 136 may be assigned with respective IP4=10.10.10.4, IP5=10.10.10.5 and IP6=10.10.10.6.

At 410 in FIG. 4, to facilitate cross-cloud traffic forwarding, first routing information accessible by EDGE1 110 may be configured to include a routing entry (see 411) that associates (a) destination network=10.10.10.0/24 with (b) a next hop associated with SERVICE1 141. Similarly, at 420 in FIG. 4, second routing information accessible by EDGE2 120 may be configured to include a routing entry (see 421) that associates (a) destination network=192.168.12.0/24 with (b) a next hop associated with SERVICE1 141. In practice, routing information 410/420 may be configured based on an exchange of route advertisements (see 405) between EDGE1 110 and EDGE2 120 over SERVICE1 141.

At 430 in FIG. 4, a set of multiple flows may be forwarded between public cloud environment 101 and on-premises data center 102 based on routing information 410/420. For simplicity, three bidirectional flows are considered (see 431-433). In practice, in response to detecting egress packets that are destined for second network=10.10.10.0/24, EDGE1 110 may forward the egress packets using SERVICE1 141 towards EDGE2 120 based on first routing information 410. One example may be egress packets associated with a first flow (F1) from source VM1 131 (i.e., IP1=192.168.12.1) to destination VM4 134 (i.e., IP4=10.10.10.4). Another example may be egress packets associated with a second flow (F2) from source VM2 132 (i.e., IP2=192.168.12.2) to destination VM5 135 (i.e., IP5=10.10.10.5). See 431-432 in FIG. 4.

Similarly, in response to detecting egress packets that are destined first network=192.168.12.0/24, EDGE2 120 may forward the egress packets using SERVICE1 141 towards EDGE1 110 based on second routing information 420. One example may be egress packets (i.e., egress from the perspective of EDGE2 120) that are associated with a third flow (F2) from source VM6 136 (i.e., IP6=10.10.10.6) to destination VM3 133 (i.e., IP3=192.168.12.3). See 433 in FIG. 4.

### (b) Metric Information

At 440-450 in FIG. 4, at multiple time intervals, EDGE1 110 may obtain real-time metric information associated with multiple connectivity services 141-142 and/or set of multiple flows 430. For example, EDGE1 110 may implement a scheduler (not shown) that is invoked at every predetermined time interval (e.g., five minutes) to obtain metric information in time series format. The metric information may be obtained from analytics system(s) 401 (one shown for simplicity) implemented using any suitable technology, such as VMware vRealize® Network Insight (VRNI)™, VMware NSX® Intelligence™, Amazon CloudWatch, Wavefront® by VMWare, etc. See also blocks 310-312 in FIG. 3.

For example, EDGE1 110 may obtain metric information 450 associated with SERVICE1 141 and/or SERVICE2 142 using any suitable application programming interface (API) and/or command line interface (CLI) supported by analytics system 401, etc. Example metric information (METRIC1) 451 associated with SERVICE1 141 (e.g., DX) may include throughput, cumulative bandwidth, connection state (e.g., UP or DOWN), bitrate for egress/ingress data, packet rate for egress/ingress data, error count, connection light level indicating the health of fiber connection, encryption state, etc.

Example metric information (METRIC2) 452 associated with SERVICE2 142 (e.g., VPN tunnel) may include VPN tunnel state, bytes received on public cloud environment's 101 side of the connection through the VPN tunnel, bytes sent from the public cloud environment's 101 side of the connection through the VPN tunnel, etc. In practice, the event that a VPN tunnel terminates on EDGE1 110 itself, EDGE1 110 may monitor metric information associated with the VPN tunnel directly.

Example metric information associated with set of multiple flows 430 may include average or maximum round trip time, total number of bytes sent by the destination of a flow, total number of packets exchanged between the source and the destination of a flow, packet loss, retransmitted packet ratio, total number of bytes sent by the source of a flow, ratio of retransmitted packets to the number of transmitted Transmission Control Protocol (TCP) packets, traffic rate, etc. Additionally, workload traffic patterns during peak or non-peak office hours may be observed and learned.

### Scaling UP

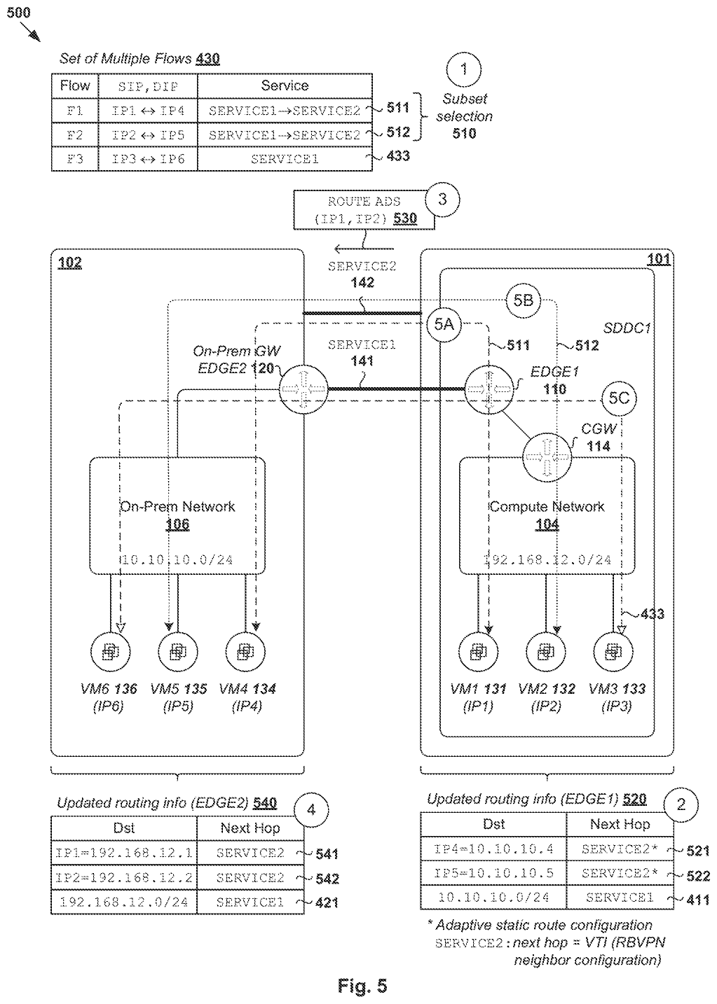

FIG. 5 is a schematic diagram illustrating example adaptive traffic forwarding 500 when a condition for scaling UP is satisfied. Here, based on metric information 450 in FIG. 4, EDGE1 110 may determine whether a condition for scaling UP or DOWN is satisfied. Any suitable condition may be configured manually and/or programmatically by a user (e.g., network administrator). One example condition may be a cumulative bandwidth associated with SERVICE1 141 exceeding a threshold limit (e.g., set between 80-95%) for a threshold period of time. Another example may be traffic drop breaches a threshold limit for a threshold period of time. See also blocks 320-321 and 330 in FIG. 3.

### (a) Subset Selection

At 510 in FIG. 5, in response to determination that the condition for scaling UP is satisfied, EDGE1 110 may select a subset from set of multiple flows 430 that may traverse over to SERVICE2 142. The selection may be based on a user-configurable policy specifying a whitelist and/or blacklist of application segment(s) or traffic type(s) that may traverse over to SERVICE2 142. For example, VM migration traffic may be assigned to SERVICE1 141 having lower latency, while workload traffic may be moved from one service to another for specific routes priority. In the example in FIG. 4, the policy may indicate that application segment=192.168.12.0/24 may be traversed over to SERVICE2 142, which may have a higher latency compared to SERVICE1 141.

Alternatively or additionally, a default policy or algorithm may be applied to select subset 510 based on the amount of available bandwidth associated with SERVICE2 142 and the amount of bandwidth required by each flow. In the example in FIG. 5, subset 510 may be selected to include a first flow (F1) between VM1 131 and VM4 134, and a second flow (F2) between VM2 132 and VM5 135. Depending on the desired implementation, these flows may be associated with a higher priority level compared to a third flow (F3) not in subset 510. See also 511-512 in FIG. 5, and 340-352 in FIG. 3.

### (b) Updated Routing Information

At 520 in FIG. 5, EDGE1 110 may update first routing information to associate flow(s) in subset 510 with a next hop associated with SERVICE2 142, such as by installing adaptive static routes 521-522. In the example in FIG. 5, first adaptive static route 521 associates (a) destination information IP4=10.10.10.4 assigned to VM4 134 with (b) next hop=RBVPN virtual tunnel interface (VTI) associated with SERVICE2 142. Second adaptive static route 522 associates (a) destination IP5=10.10.10.5 assigned to VM5 135 with (b) next hop=RBVPN VTI associated with SERVICE2 142. See also 360-361 in FIG. 3.

At 530 in FIG. 5, if symmetric routing for the return traffic is configured, EDGE1 110 may generate and send adaptive route advertisement(s) using SERVVICE2 142 to EDGE2 120 at multiple time intervals. Any suitable route advertising protocol(s) may be used, such as BGP, external BGP (eBGP), etc. In response, at 540, EDGE2 120 may update its routing information to include first advertised route 541 that associates (a) destination IP1=192.168.12.1 of VM1 131 with (b) next hop-on-premises VTI associated with SERVICE2 142. Second advertised route 542 may associate (a) destination IP2=192.168.12.2 of VM2 132 with (b) next hop=on-premises VTI associated with SERVICE2 142. Since these will be specific networks for the peer gateway, routes 541-542 will take priority over existing routing information 421. See also block 362 in FIG. 3.

Using examples of the present disclosure, EDGE1 110 may install adaptive static routes 521-522 to steer flows from one service to another. Further, routes 541-542 may be intelligently programmed using adaptive route advertisements between EDGE1 110 and EDGE2 120. Depending on the desired implementation, firewall state synchronization may be implemented across interfaces for SERVICE1 141 (e.g., DX) and SERVICE2 142 (e.g., VPN) at both cloud environments 101-102. This is to maintain firewall state awareness across interfaces/services for a particular flow so that asymmetric traffic is not dropped.

### (c) Adaptive Traffic Forwarding

Based on updated routing information 520 (particularly 521-522), EDGE1 110 may forward egress packets destined for IP4=10.10.10.4 or IP5=10.10.10.5 towards EDGE2 120 using SERVICE2 142. Similarly, based on updated routing information 540 (particularly 541-542), EDGE2 120 may forward egress packets destined for IP1=192.168.12.1 or IP2=192.168.12.2 towards EDGE1 110 using SERVICE2 142. See also 370 in FIG. 3, and 511-512 in FIG. 5.

For a third flow (F3) that is not selected to be part of subset 510, however, EDGE1 110 may continue using SERVICE1 141 to forward egress packets destined for IP6=10.10.10.6 towards EDGE2 120 based on the existing routing entry for destination network=10.10.10.0/24 (see 411 and 433 in FIGS. 4-5). Similarly, EDGE2 120 may continue using SERVICE1 141 to forward return traffic destined for IP3=192.168.12.3 towards EDGE1 110 based on the existing routing entry for destination network=192.168.12.0/24 (see 421 and 433 in FIGS. 4-5).

Depending on the desired implementation, an adaptive static route installed by EDGE1 110 may specify a classless inter-domain routing (CIDR) block, instead of a particular destination IP address shown in FIG. 5. In this case, EDGE1 110 may break up or divide destination network=10.10.10.0/24 into more specific /32 or /28 networks that are advertised over secondary SERVICE2 142. Super subnets may be advertised over primary SERVICE1 141 such that the remaining flows (i.e., not in subset 510) may continue to use SERVICE1 141.

### Scaling DOWN

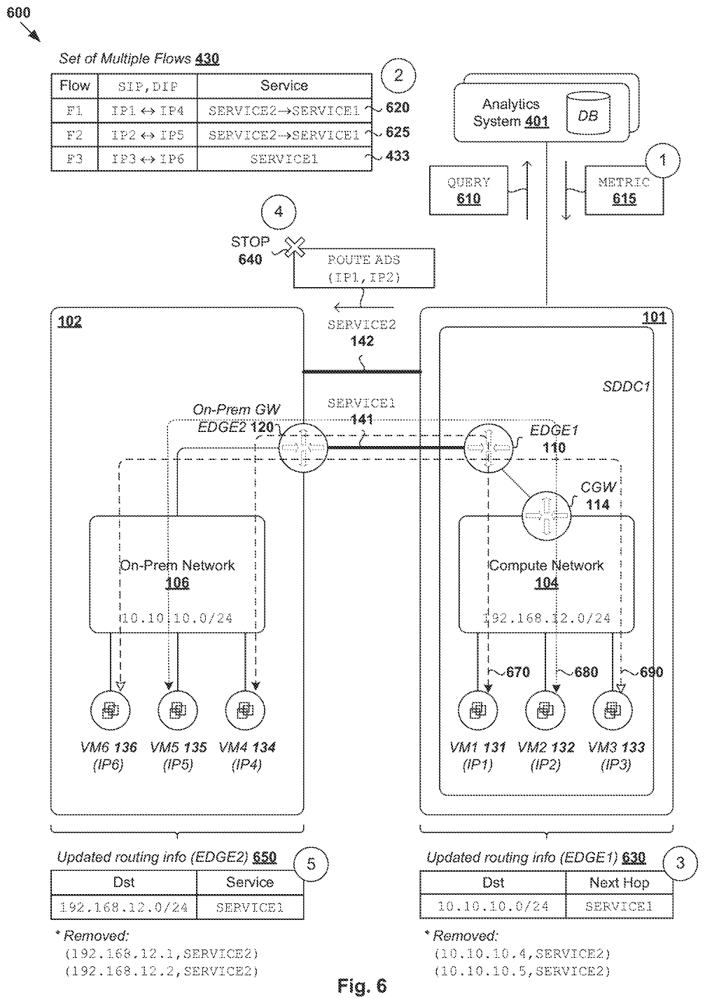

FIG. 6 is a schematic diagram illustrating example adaptive traffic forwarding 600 when a condition for scaling DOWN is satisfied. At 610-615, based on updated metric information obtained from analytics system(s) 401, EDGE1 110 may determine that a condition for scaling DOWN is satisfied. In this case, at 620-625, EDGE1 110 may decide to move flows=(F1, F2) in subset 510 from SERVICE2 142 to SERVICE1 141, which may have a lower latency.

One example condition for scaling DOWN may be an observation that the cumulative bandwidth or throughput (e.g., moving average) associated with SERVICE1 141 is lower than a threshold value for a threshold period of time. Another example condition is the total traffic (i.e., over both SERVICE1 141 and SERVICE2 142) is lower than a threshold amount of traffic that can be supported by SERVICE1 141 for a threshold amount of time.

### (a) Updated Routing Information

At 630 in FIG. 6, EDGE1 110 may update routing information to re-associate subset 510 with SERVICE1 141. This involves identifying and removing or uninstalling adaptive static routes 521-522 in FIG. 5. In particular, first static route 521 specifying (destination IP4=10.10.10.4, next hop associated with SERVICE2 142) and second static route 522 specifying (destination IP5=10.10.10.5, next hop associated with SERVICE2) may be removed. The entries may be removed as a single unit operation.

At 640 in FIG. 6, if symmetric routing is configured for the return traffic, EDGE1 110 may stop sending route advertisement(s) for destination IP1=192.168.12.1 and IP2=192.168.12.2 over SERVICE2 142 towards EDGE2 120. In response, at 650 in FIG. 6, advertised routes 541-542 may be aged and removed. The entries may be removed as a single unit operation. See also 380 (scaling DOWN condition met) and 390-392 in FIG. 3.

### (c) Adaptive Traffic Forwarding

Based on updated routing information 630, EDGE1 110 may forward egress packets destined for 10.10.10.0/24 (i.e., including IP4=10.10.10.4 and IP5=10.10.10.5) towards EDGE2 120 using SERVICE1 141. Based on updated routing information 650, EDGE2 120 may forward egress packets destined for 192.168.12.0/24 (i.e., including IP1=192.168.12.1 and IP2=192.168.12.2) towards EDGE1 110 using SERVICE1 141. See block 395 in FIG. 3 and 670-690 in FIG. 6.

### Additional Use Cases

Throughout the present disclosure, various examples will be explained using SERVICE1 141 as a primary service, and SERVICE2 142 as a secondary or backup service. In practice, the reverse may also be configured, i.e., SERVICE2 142 (e.g., VPN) as primary and SERVICE1 141 (e.g., DX) as backup. For example, consider a scenario where the bandwidth available for SERVICE2 142 is 5 Gbps, while SERVICE1 141 includes two pipes with a total of 2 Gbps. Until traffic is up to 5 Gbps, SERVICE2 142 may take priority.

In response to determination that a condition for scaling UP is satisfied, EDGE1 110 may perform blocks 310-370 in FIG. 3 to initiate a scale UP to move a subset of flow(s) from SERVICE2 142 to SERVICE1 141. Here, route aggregation may be used by EDGE1 110 to advertise local networks or subnets over SERVICE1 141. Similarly, In response to determination that a condition for scaling DOWN is satisfied, EDGE1 110 may perform blocks 310-320 and 380-395 in FIG. 3 to move the subset of flow(s) from SERVICE1 141 to SERVICE2 142. Various implementation details discussed above are applicable here and will not be repeated for brevity.

Alternatively or additionally, it should be understood that EDGE2 120 may perform the example in FIG. 3 initiate a scale UP or DOWN. Here, SERVICE1 141 may be configured as a primary service, and SERVICE2 142 as a backup service, or vice versa. Further, there may be multiple backup services configured. In this case, traffic from primary SERVICE1 141 may be distributed among SERVICE2 142 and a further service (e.g., SERVICE3), for example.

In another example, asymmetric distribution of traffic over multiple dedicated links (e.g., DX links) may be implemented based on different available link bandwidths or configurations, such as a first link providing 10 Gbps (“SERVICE1”) and a second link providing 1 Gbps (“SERVICE2”). In this case, the 10 Gbps link may be configured as a primary link, and the 1 Gbps as secondary link. In response to determination that a scaling UP condition is satisfied, a subset of flow(s) may be selected and steered from the primary link to the secondary link according to examples of the present disclosure. Any additional and/or alternative connectivity services may be implemented to facilitate cross-cloud traffic forwarding, such as Microsoft Azure® ExpressRoute, Google® Cloud Interconnect, etc.

### Management Entity Example

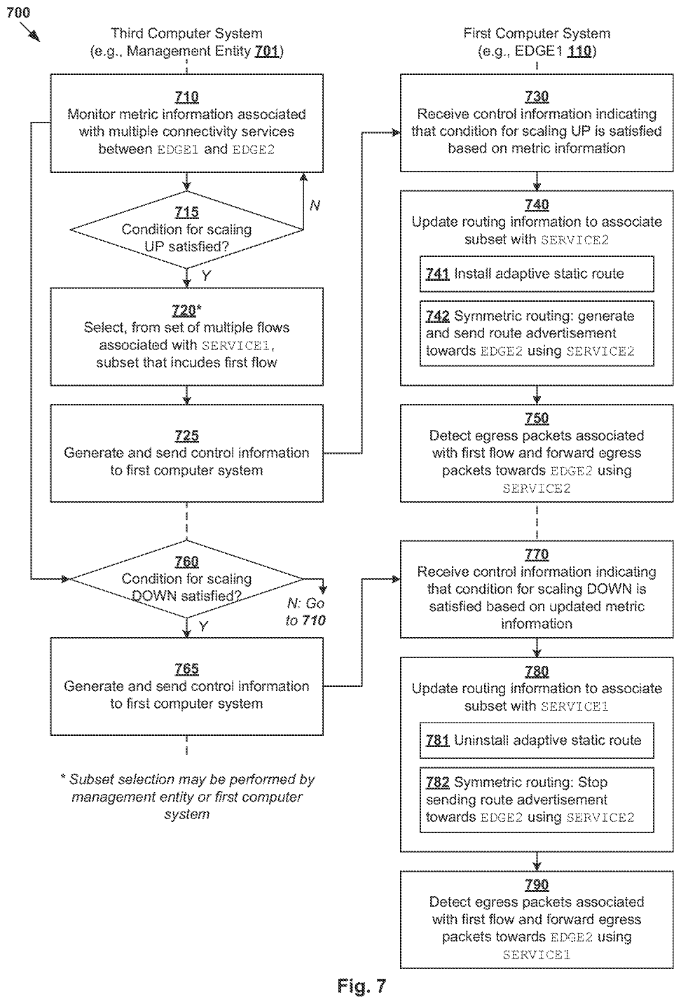

According to at least one embodiment, a management entity may be deployed to instruct EDGE1 110 and/or EDGE2 120 to perform adaptive traffic forwarding. Some examples will be described using FIG. 7, which is a flowchart of an example process 700 for a first computer system to perform adaptive traffic forwarding over multiple connectivity services based on control information from a management entity. In the following, EDGE1 110 will be described as an example “first computer system.” Additionally or alternatively, EDGE2 120 may be configured to perform adaptive traffic forwarding based on control information from a management entity (denoted as 701 in FIG. 7).

Depending on the desired implementation, management entity 701 (e.g., central manager) may be implemented using any suitable third computer system that is capable of a multi-cloud environment that includes first cloud environment 101 and second cloud environment 102. For example, management entity 701 may have access to configuration information associated with both cloud environments 101-102, as well as metric information associated with multiple connectivity services connecting them. In the following, various implementation details explained using FIGS. 1-6 are also applicable to the example in FIG. 7. These details are not repeated in full below for brevity.

### (a) Scaling UP

At 710-715 in FIG. 7, management entity 701 may monitor metric information and determine that a condition for scaling UP is satisfied based on the metric information. The metric information may be associated with at least SERVICE1 141 from multiple (N) connectivity services 140 that are connecting EDGE1 110 and EDGE2 120. Using example in FIG. 1, multiple (N) connectivity services 140 may include SERVICE1 141 (e.g., DX) configured as a primary service and SERVICE2 142 (e.g., VPN) configured as a backup service. Management entity 701 may perform metric information monitoring based on information from EDGE 110/120, data analytics system 401 in FIG. 4, any third party system, or any combination thereof.

At 720 in FIG. 7, in response to determination that a condition for scaling UP is satisfied based on the metric information, management entity 701 may select a subset from a set of multiple flows associated with SERVICE1 141. For example, the subset may include a first flow that is selected based on a policy specifying that an application segment or traffic type associated with the first flow is moveable from SERVICE1 141 to SERVICE2 142. In another example, the first flow may be selected based an amount of available bandwidth associated with SERVICE2 142 and an amount of bandwidth required by the first flow. Subset selection at block 720 may be performed by management entity 701 or EDGE1 110.

At 725-730 in FIG. 7, EDGE1 110 may receive control information from management entity 701. The control information may indicate that a condition for scaling UP is satisfied based on metric information monitored by management entity 701. Based on the control information, EDGE1 110 may identify the subset that is selected from the set of multiple flows associated with SERVICE1 141. In one example (shown in FIG. 7), subset selection according to block 720 may be performed by management entity 701. Alternatively, block 720 may be performed by EDGE1 110.

At 740 in FIG. 7, based on the control information, EDGE1 110 may update routing information to associate the subset with SERVICE2 142 instead of SERVICE1 141. For example, at 741, block 740 may involve installing an adaptive static route that associates a destination address of the first flow in subset 160 with a next hop (e.g., interface) associated with SERVICE2 142. Optionally, at 742, to facilitate symmetric routing for the return traffic, EDGE1 110 may generate and send route advertisement(s) associated with the first flow towards EDGE2 120 using SERVICE2 142.

At 750 in FIG. 7, in response to detecting egress packets from a first endpoint (e.g., VM1 131) associated with the first flow, EDGE1 110 may forward the egress packets towards EDGE2 120 using SERVICE2 142 based on the updated routing information. Once received via SERVICE2 142, EDGE2 120 may forward the egress packets towards a second endpoint (e.g., VM4 134) in private cloud environment 102.

### (b) Scaling DOWN

At 760-765 in FIG. 7, in response to determination that a condition for scaling DOWN is satisfied based on updated metric information, management entity 701 may generate and send further control information to EDGE1 110. The control information is to cause EDGE1 110 to perform blocks 770-790.

At 770 in FIG. 7, EDGE1 110 may receive further control information indicating that a condition for scaling DOWN is satisfied from management entity 701. At 780, based on the control information, EDGE1 110 may update routing information to re-associate the subset with SERVICE1 141. For example, at 781, EDGE1 110 may remove or uninstall the adaptive static route installed at block 741. Optionally, at 782, to facilitate symmetric routing for the return traffic, EDGE1 110 may stop sending the route advertisement(s) at block 741.

At 790 in FIG. 7, in response to detecting egress packets from a first endpoint (e.g., VM1 131) associated with the first flow, EDGE1 110 may forward the egress packets towards EDGE2 120 using SERVICE1 141 based on the updated routing information. Once received via SERVICE1 141, EDGE2 120 may forward the egress packets towards a second endpoint (e.g., VM4 134) in private cloud environment 102.

### Physical Implementation View

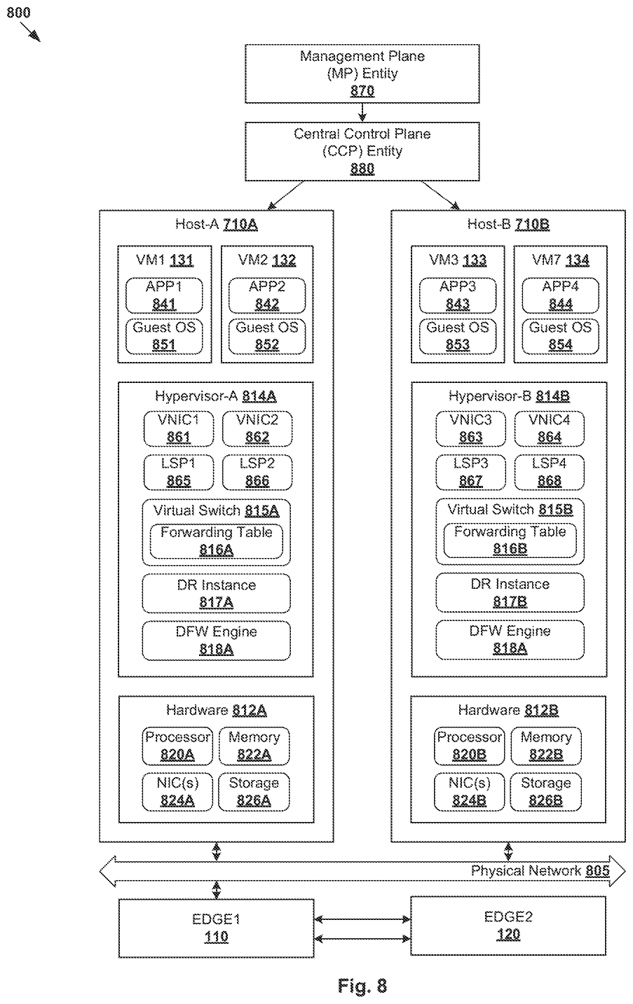

FIG. 8 is a schematic diagram illustrating example physical implementation view 800 of endpoints in SDN environment 100. It should be understood that, depending on the desired implementation, FIG. 8 may include additional and/or alternative components. In practice, SDN environment 100 may include any number of hosts (also known as “computer systems,” “computing devices”, “host computers”, “host devices”, “physical servers”, “server systems”, “transport nodes,” etc.).

In the example in FIG. 8, cloud environment 101 may include host-A 810A and host-B 810B. Host 810A/810B may include suitable hardware 812A/812B and virtualization software (e.g., hypervisor-A 814A, hypervisor-B 814B) to support various VMs. For example, host-A 810A may support VM1 131 and VM2 132, while VM3 133 and VM7 837 are supported by host-B 810B. Hardware 812A/812B includes suitable physical components, such as central processing unit(s) (CPU(s)) or processor(s) 820A/820B; memory 822A/822B; physical network interface controllers (PNICs) 824A/824B; and storage disk(s) 826A/826B, etc.

Hypervisor 814A/814B maintains a mapping between underlying hardware 812A/812B and virtual resources allocated to respective VMs. Virtual resources are allocated to respective VMs 131-133, 837 to support a guest operating system (OS; not shown for simplicity) and application(s); see 841-844, 851-854. For example, the virtual resources may include virtual CPU, guest physical memory, virtual disk, virtual network interface controller (VNIC), etc. Hardware resources may be emulated using virtual machine monitors (VMMs). For example in FIG. 8, VNICs 861-864 are virtual network adapters for VMs 131-134, respectively, and are emulated by corresponding VMMs (not shown) instantiated by their respective hypervisor at respective host-A 810A and host-B 810B. The VMMs may be considered as part of respective VMs, or alternatively, separated from the VMs. Although one-to-one relationships are shown, one VM may be associated with multiple VNICs (each VNIC having its own network address).

Although examples of the present disclosure refer to VMs, it should be understood that a “virtual machine” running on a host is merely one example of a “virtualized computing instance” or “workload.” A virtualized computing instance may represent an addressable data compute node (DCN) or isolated user space instance. In practice, any suitable technology may be used to provide isolated user space instances, not just hardware virtualization. Other virtualized computing instances may include containers (e.g., running within a VM or on top of a host operating system without the need for a hypervisor or separate operating system or implemented as an operating system level virtualization), virtual private servers, client computers, etc. Such container technology is available from, among others, Docker, Inc. The VMs may also be complete computational environments, containing virtual equivalents of the hardware and software components of a physical computing system.

The term “hypervisor” may refer generally to a software layer or component that supports the execution of multiple virtualized computing instances, including system-level software in guest VMs that supports namespace containers such as Docker, etc. Hypervisors 814A-B may each implement any suitable virtualization technology, such as VMware ESX® or ESXi™ (available from VMware, Inc.), Kernel-based Virtual Machine (KVM), etc. The term “packet” may refer generally to a group of bits that can be transported together, and may be in another form, such as “frame,” “message,” “segment,” etc. The term “traffic” or “flow” may refer generally to multiple packets. The term “layer-2” may refer generally to a link layer or media access control (MAC) layer; “layer-3” a network or IP layer; and “layer-4” a transport layer (e.g., using Transmission Control Protocol (TCP), User Datagram Protocol (UDP), etc.), in the Open System Interconnection (OSI) model, although the concepts described herein may be used with other networking models.

SDN controller 870 and SDN manager 880 are example network management entities. One example of an SDN controller is the NSX controller component of VMware NSX® (available from VMware, Inc.) that operates on a central control plane. SDN controller 870 may be a member of a controller cluster (not shown for simplicity) that is configurable using SDN manager 880. Network management entity 870/880 may be implemented using physical machine(s), VM(s), or both. To send or receive control information, a local control plane (LCP) agent (not shown) on host 810A/810B may interact with SDN controller 870 via a control-plane channel.

Through virtualization of networking services in SDN environment 100, logical networks (also referred to as overlay networks or logical overlay networks) may be provisioned, changed, stored, deleted and restored programmatically without having to reconfigure the underlying physical hardware architecture. Hypervisor 814A/814B implements virtual switch 815A/815B and logical distributed router (DR) instance 817A/817B to handle egress packets from, and ingress packets to, VMs 131-133, 837. In SDN environment 100, logical switches and logical DRs may be implemented in a distributed manner and can span multiple hosts.

For example, a logical switch (LS) may be deployed to provide logical layer-8 connectivity (i.e., an overlay network) to VMs 131-133, 837. A logical switch may be implemented collectively by virtual switches 815A-B and represented internally using forwarding tables 816A-B at respective virtual switches 815A-B. Forwarding tables 816A-B may each include entries that collectively implement the respective logical switches. Further, logical DRs that provide logical layer-3 connectivity may be implemented collectively by DR instances 817A-B and represented internally using routing tables (not shown) at respective DR instances 817A-B. Each routing table may include entries that collectively implement the respective logical DRs.

Packets may be received from, or sent to, each VM via an associated logical port. For example, logical switch ports 865-868 (labelled “LSP1” to “LSP4”) are associated with respective VMs 131-133, 837. Here, the term “logical port” or “logical switch port” may refer generally to a port on a logical switch to which a virtualized computing instance is connected. A “logical switch” may refer generally to a software-defined networking (SDN) construct that is collectively implemented by virtual switches 815A-B, whereas a “virtual switch” may refer generally to a software switch or software implementation of a physical switch. In practice, there is usually a one-to-one mapping between a logical port on a logical switch and a virtual port on virtual switch 815A/815B. However, the mapping may change in some scenarios, such as when the logical port is mapped to a different virtual port on a different virtual switch after migration of the corresponding virtualized computing instance (e.g., when the source host and destination host do not have a distributed virtual switch spanning them).

A logical overlay network may be formed using any suitable tunneling protocol, such as Virtual extensible Local Area Network (VXLAN), Stateless Transport Tunneling (STT), Generic Network Virtualization Encapsulation (GENEVE), Generic Routing Encapsulation (GRE), etc. For example, VXLAN is a layer-8 overlay scheme on a layer-3 network that uses tunnel encapsulation to extend layer-8 segments across multiple hosts which may reside on different layer 8 physical networks. Hypervisor 814A/814B may implement virtual tunnel endpoint (VTEP) 819A/819B to encapsulate and decapsulate packets with an outer header (also known as a tunnel header) identifying the relevant logical overlay network (e.g., VNI). Hosts 810A-B may maintain data-plane connectivity with each other via physical network 805 to facilitate east-west communication among VMs 131-133, 837. Hosts 810A-B may also maintain data-plane connectivity with EDGE1 110 in FIG. 8 via physical network 805 to facilitate north-south traffic forwarding, such as between VM1 131 at first cloud environment 101 and VM4 134 at second cloud environment 102 via EDGE2 120.

### Container Implementation

Although discussed using VMs 131-136, it should be understood that adaptive traffic forwarding may be performed for other virtualized computing instances, such as containers, etc. The term “container” (also known as “container instance”) is used generally to describe an application that is encapsulated with all its dependencies (e.g., binaries, libraries, etc.). For example, multiple containers may be executed as isolated processes inside VM1 131, where a different VNIC is configured for each container. Each container is “OS-less”, meaning that it does not include any OS that could weigh 10s of Gigabytes (GB). This makes containers more lightweight, portable, efficient and suitable for delivery into an isolated OS environment. Running containers inside a VM (known as “containers-on-virtual-machine” approach) not only leverages the benefits of container technologies but also that of virtualization technologies.

### Computer System

The above examples can be implemented by hardware (including hardware logic circuitry), software or firmware or a combination thereof. The above examples may be implemented by any suitable computing device, computer system, etc. The computer system may include processor(s), memory unit(s) and physical NIC(s) that may communicate with each other via a communication bus, etc. The computer system may include a non-transitory computer-readable medium having stored thereon instructions or program code that, when executed by the processor, cause the processor to perform processes described herein with reference to FIG. 1 to FIG. 8. For example, a first/second computer system capable of acting as EDGE 110/120 and/or a third computer system capable of acting as management entity 701 may be deployed to perform examples of the present disclosure.

The techniques introduced above can be implemented in special-purpose hardwired circuitry, in software and/or firmware in conjunction with programmable circuitry, or in a combination thereof. Special-purpose hardwired circuitry may be in the form of, for example, one or more application-specific integrated circuits (ASICs), programmable logic devices (PLDs), field-programmable gate arrays (FPGAs), and others. The term ‘processor’ is to be interpreted broadly to include a processing unit, ASIC, logic unit, or programmable gate array etc.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or any combination thereof.

Those skilled in the art will recognize that some aspects of the embodiments disclosed herein, in whole or in part, can be equivalently implemented in integrated circuits, as one or more computer programs running on one or more computers (e.g., as one or more programs running on one or more computing systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure.

Software and/or to implement the techniques introduced here may be stored on a non-transitory computer-readable storage medium and may be executed by one or more general-purpose or special-purpose programmable microprocessors. A “computer-readable storage medium”, as the term is used herein, includes any mechanism that provides (i.e., stores and/or transmits) information in a form accessible by a machine (e.g., a computer, network device, personal digital assistant (PDA), mobile device, manufacturing tool, any device with a set of one or more processors, etc.). A computer-readable storage medium may include recordable/non recordable media (e.g., read-only memory (ROM), random access memory (RAM), magnetic disk or optical storage media, flash memory devices, etc.).

The drawings are only illustrations of an example, wherein the units or procedure shown in the drawings are not necessarily essential for implementing the present disclosure. Those skilled in the art will understand that the units in the device in the examples can be arranged in the device in the examples as described or can be alternatively located in one or more devices different from that in the examples. The units in the examples described can be combined into one module or further divided into a plurality of sub-units.

What is claimed is:

1. A method for a first computer system to perform adaptive traffic forwarding, wherein the method comprises:
monitoring metric information associated with at least a first connectivity service from multiple connectivity services that are connecting (a) the first computer system located in a first cloud environment at a first geographical site and (b) a second computer system located in a second cloud environment at a second geographical site;
in response to determination that a condition for scaling up is satisfied based on the metric information,
selecting, from a set of multiple flows associated with the first connectivity service, a subset that includes at least a first flow between a first endpoint located in the first cloud environment and a second endpoint located in the second cloud environment; and
updating routing information to associate the subset with a second connectivity service from the multiple connectivity services; and
in response to detecting egress packets associated with the first flow from the first endpoint, forwarding the egress packets towards the second computer system using the second connectivity service based on the updated routing information to cause the second computer system to forward the egress packets towards the second endpoint.

2. The method of claim 1, wherein updating routing information comprises:
installing an adaptive static route that associates (a) destination information associated with the second endpoint of the first flow with (b) a next hop associated with the second connectivity service at the first computer system.

3. The method of claim 2, wherein the method further comprises:
sending, at multiple time intervals, a route advertisement towards the second computer system to cause the second computer system to update routing information to associate (a) destination information associated with the first endpoint with (b) a next hop associated with the second connectivity service at the second computer system.

4. The method of claim 2, wherein the method further comprises:
in response to determination that a condition for scaling down is satisfied based on updated metric information, uninstalling the adaptive static route to cause forwarding of subsequent egress packets associated with the first flow using the first connectivity service.

5. The method of claim 3, wherein the method further comprises:
in response to determination that a condition for scaling down is satisfied based on updated metric information, stop sending the route advertisement towards the second computer system.

6. The method of claim 1, wherein selecting the subset comprises:
selecting the first flow based on a policy specifying an application segment or traffic type associated with the first flow is moveable from the first connectivity service to the second connectivity service.

7. The method of claim 1, wherein selecting the subset comprises:
selecting the first flow based an amount of available bandwidth associated with the second connectivity service and an amount of bandwidth required by the first flow.

8. A non-transitory computer-readable storage medium that includes a set of instructions which, in response to execution by a processor of a first computer system, cause the processor to perform a method of adaptive traffic forwarding, wherein the method comprises:
monitoring metric information associated with at least a first connectivity service from multiple connectivity services that are connecting (a) the first computer system located in a first cloud environment at a first geographical site and (b) a second computer system located in a second cloud environment at a second geographical site;
in response to determination that a condition for scaling up is satisfied based on the metric information,
selecting, from a set of multiple flows associated with the first connectivity service, a subset that includes at least a first flow between a first endpoint located in the first cloud environment and a second endpoint located in the second cloud environment; and
updating routing information to associate the subset with a second connectivity service from the multiple connectivity services; and
in response to detecting egress packets associated with the first flow from the first endpoint, forwarding the egress packets towards the second computer system using the second connectivity service based on the updated routing information to cause the second computer system to forward the egress packets towards the second endpoint.

9. The non-transitory computer-readable storage medium of claim 8, wherein updating routing information comprises:
installing an adaptive static route that associates (a) destination information associated with the second endpoint of the first flow with (b) a next hop associated with the second connectivity service at the first computer system.

10. The non-transitory computer-readable storage medium of claim 9, wherein the method further comprises:
sending, at multiple time intervals, a route advertisement towards the second computer system to cause the second computer system to update routing information to associate (a) destination information associated with the first endpoint with (b) a next hop associated with the second connectivity service at the second computer system.

11. The non-transitory computer-readable storage medium of claim 9, wherein the method further comprises:
in response to determination that a condition for scaling down is satisfied based on updated metric information, uninstalling the adaptive static route to cause forwarding of subsequent egress packets associated with the first flow using the first connectivity service.

12. The non-transitory computer-readable storage medium of claim 10, wherein the method further comprises:
in response to determination that a condition for scaling down is satisfied based on updated metric information, stop sending the route advertisement towards the second computer system.

13. The non-transitory computer-readable storage medium of claim 8, wherein selecting the subset comprises:
selecting the first flow based on a policy specifying an application segment or traffic type associated with the first flow is moveable from the first connectivity service to the second connectivity service.

14. The non-transitory computer-readable storage medium of claim 8, wherein selecting the subset comprises:
selecting the first flow based an amount of available bandwidth associated with the second connectivity service and an amount of bandwidth required by the first flow.

15. A first computer system, comprising:
a processor; and
a non-transitory computer-readable medium having stored thereon instructions that, when executed by the processor, cause the processor to perform the following:
receiving, from a management entity, control information indicating that a condition for scaling up is satisfied based on metric information associated with at least a first connectivity service from multiple connectivity services that are connecting (a) the first computer system located in a first cloud environment at a first geographical site and (b) a second computer system located in a second cloud environment at a second geographical site;
based on the control information, update routing information to associate a subset with a second connectivity service from the multiple connectivity services, wherein the subset is selected from a set of multiple flows associated with the first connectivity service, and includes a first flow between a first endpoint located in the first cloud environment and a second endpoint located in the second cloud environment; and
in response to detecting egress packets associated with the first flow from the first endpoint, forward the egress packets towards the second computer system using the second connectivity service based on the updated routing information to cause the second computer system to forward the egress packets towards the second endpoint.

16. The first computer system of claim 15, wherein the instructions for updating routing information cause the processor to:
install an adaptive static route that associates (a) destination information associated with the second endpoint of the first flow with (b) a next hop associated with the second connectivity service at the first computer system.

17. The first computer system of claim 16, wherein the instructions further cause the processor to:
send, at multiple time intervals, a route advertisement towards the second computer system to cause the second computer system to update routing information to associate (a) destination information associated with the first endpoint with (b) a next hop associated with the second connectivity service at the second computer system.

18. The first computer system of claim 16, wherein the instructions further cause the processor to:
receive, from the management entity, further control information indicating that a condition for scaling down is satisfied based on updated metric information;
based on the further control information, uninstall the adaptive static route to cause forwarding of subsequent egress packets associated with the first flow using the first connectivity service.

19. The first computer system of claim 17, wherein the instructions further cause the processor to:
receive, from the management entity, further control information indicating that a condition for scaling down is satisfied based on updated metric information; and
stop sending the route advertisement towards the second computer system.

20. The first computer system of claim 15, wherein the instructions for updating the routing information cause the processor to:
update the routing information to associate the first flow with the second connectivity service, wherein the first flow is selected by the first computer system or the management entity based on a policy specifying an application segment or traffic type associated with the first flow is moveable from the first connectivity service to the second connectivity service.

21. The first computer system of claim 15, wherein the instructions for updating the routing information cause the processor to:
update the routing information to associate the first flow with the second connectivity service, wherein the first flow is selected by the first computer system or the management entity based an amount of available bandwidth associated with the second connectivity service and an amount of bandwidth required by the first flow.
